(19) United States
(12) Patent Application Publication
(10) Pub. No.: US 2025/0198083 A1
(43) Pub. Date: Jun. 19, 2025

(54) REGENERATING CELLULOSE FROM WASTE TEXTILE

(71) Applicant: PHOENXT PTY. LTD, New South Whales (AU)

(72) Inventor: Raha Saremi, Hull, GA (US)

(21) Appl. No.: 18/849,728

(22) PCT Filed: Mar. 16, 2023
(86) PCT No.: PCT/EP2023/056797

§ 371 Date: Sep. 23, 2024

Related U.S. Application Data
(60) Provisional application No. 63/321,894, filed on Mar. 21, 2022.

(51) Int. Cl. D21C 5/00; C08B 16/00

(52) U.S. Cl. CPC D21C 5/00; C08B 16/00

(57) ABSTRACT

A system and method for regenerating cellulose (45) and/or polyester (46) from waste textile (15) are disclosed. The method (100) comprises the steps of providing (S110) samples (20) to a container (25), providing (S120) an aqueous solution of high concentration, i.e., at least 85% (w/w), NMMO (35) to the container (25), heating (S150) the container (25) comprising the provided samples (20) to a specific temperature for a heating time of 2 to 3 hours thereby creating a mixture (40), re-filtering (S190) the mixture (40) using a vacuum filtration device (85), and drying (S200) the re-filtered mixture (40) using a vacuum oven (90).

This application claims benefit of and priority to the provisional U.S. patent application No. 63/321,894 filed on 21 Mar. 2022.

### FIELD OF THE INVENTION

The field of the invention relates to a system and method for regenerating cellulose from cotton/polyester/cellulosic fiber blends of fabrics and for providing a process for the reusing of a solvent used in the method.

### BACKGROUND OF THE INVENTION

The environmental impact of the fashion industry has been a growing concern for many consumers in the recent years. One of the main reasons for this concern is caused by short fashion cycles leading to immense amounts of waste. Used fashion products, unsold fashion products, and production scrap are discarded every year causing immense amounts of waste. This fashion waste is often not properly recycled, thereby filling landfills, or being destroyed in waste incineration plants. Many consumers have become increasingly aware of this waste and the associated ecological effects. Different solutions have been proposed to reduce the amount of waste produced by recycling the products more efficiently. This is sometimes also referred to as “sustainable fashion” or “circular fashion”.

Recycling techniques for the fashion waste depend on the materials used in the fashion products. Different recycling systems and recycling processes (“recycling techniques”) are known for fashion products comprising polyester fibers. These recycling techniques focus on separating fibers in the fashion waste and using these separated fibers as a fiber source in new fashion products. The known solutions are, for example, applicable for recycling blended fibers such as polyester, cotton, and other plant-based natural cellulosic fibers, polyester/cotton fibers and polyester/cellulosic fiber mixtures.

US patent application U.S. Pat. No. 5,216,144 A describes a system and method for producing shaped cellulosic articles from fibers or filaments by precipitating cellulose from a solution containing cellulose and N-methylmorpholine N-oxide (NMMO). The cellulose is dissolved in the NMMO, and water is coagulated in a NMMO coagulating bath. The fibers are then washed, and the washing water is recycled to a precipitating bath. The water is evaporated during regeneration of the precipitate to allow recovery of the NMMO concentrate which can be used to form fresh solutions of the cellulose while the distillate can be employed for washing the fibers.

US patent application U.S. Pat. No. 5,189,152 A describes a further system and method for fabrication of shaped bodies by precipitating NMMO. The NMMO is used as a solvent for a spinning process. It is described in the US patent application that during the dissolution of the cellulose and/or on warming of the system, amines, such as N-methylmorpholine and morpholine, can form by decomposition of the NMMO. The decomposition of the NMMO will affect the performance of the spinning process. The system and method of US '152 aim to avoid decomposition of NMMO in a cellulose solution comprising water and NMMO. This aim is achieved by addition of a cellulose solution in water and N-methylmorpholine-N-oxide (NMMO) containing 2 to 44% by weight cellulose of 0.01 to 1% of hydrogen peroxide (H₂O₂) and 0.01 to 2% of a stabilizer for the H₂O₂. The H₂O₂ is maintained in the solution at a concentration of 0.01% and the solution also contains 0.1% of the stabilizer for the H₂O₂. The stabilizer is oxalic acid or a salt. US '152 describes reactions at temperatures of the cellulosic NMMO/water solutions of 90° C. and below. The use of bleach or H₂O₂ stabilizers is required.

US patent application U.S. Pat. No. 5,601,767 A describes a system and method for the production of a cellulose molded body, particularly cellulose fibers. The method is characterized by the combination of the measures of feeding a cellulose-containing material into an aqueous solution of a tertiary amine-oxide in order to suspend the cellulose-containing material. The method comprises removing water from the suspension while intensively mixing the suspension and providing elevated temperature and reduced pressure until a solution of cellulose is produced. The method further comprises molding the solution in a molding device such as a spinneret. The method also comprises introducing the solution into a precipitation bath in order to precipitate the dissolved cellulose.

The prior art patent document US '152 and US '767 both disclose solutions for producing cellulose molded bodies using processes requiring significant amounts of stabilizers or solvents. The solvents are disposed after use.

The prior art does not disclose a system or method for regenerating cellulose from cotton/polyester/cellulosic blends using a process enabling reusing of the solvents.

### SUMMARY OF THE INVENTION

The disclosed document describes a system and method for regenerating materials, such as cellulose and polyester, from waste textiles comprising cotton/polyester/cellulosic fiber blends of fabric. The system and method are directed at a process for reusing a NMMO (N-methylmorpholine N-oxide) solvent. The method comprises providing samples, including the waste textiles, to a container. An aqueous solution of high concentration, i.e., at least 85% (w/w), NMMO is added to the container and the container is heated to a specific temperature of at least 100° C. for a heating time of at least 2, but (in one aspect) not more than 3 hours, thereby creating a mixture. The method further comprises re-filtering the mixture using a vacuum filtration device and drying the re-filtered mixture using a vacuum oven.

The system and method of the disclosure teach the use of NMMO for dissolving blended fabrics, such as cotton/polyester/cellulosic fiber, in a way such that the polyester or the cellulosic fibers will detach from the cotton/polyester/cellulosic pulps, while the NMMO does not further harm the quality of the detached fibers. Therefore, treatment time with the NMMO, temperature, and concentration of the NMMO, as disclosed in this document, are much different from those disclosed in the prior art. In detail, application US '144 includes a treatment with an NMMO concentration of less than 40% (w/w) at ambient temperatures during the main step, i.e., the precipitating bath, of the prior art process.

The system and method of the disclosure teach the use of NMMO, where NMMO is not decomposed during the regeneration method. The method and system enable the reclamation of the cellulosic or the polyester fibers with a sufficient purity and/or quality to be reused from the blended fabrics. Furthermore, the quality of the cellulosic fibers or the polyester fibers is not harmed by the process and, therefore, the cellulosic or the polyester fibers can be turned into yarns again. The quality is evaluated by means of FTIR, XRD, TGA, and DSC tests. The conservation of quality during the method is accomplished through a tailored interaction in terms of concentration, temperature, treatment time, and probably pH value between NMMO and the blended cotton/polyester/cellulosic fiber fabrics.

Furthermore, the method is using blended cotton/polyester/cellulosic fiber fabrics as initial materials. Thus, one advantage of the disclosed method is that, besides cellulosic fibers, also polyester fibers can be reclaimed. Said advantage is distinguishing the here disclosed, e.g., from patent application U.S. Pat. No. 5,216,144 A.

Furthermore, the method teaches a recycling process by means of a solvent for cotton/polyester/cellulosic fiber blends of fabric. The term recycling process by means of a solvent unfolds into two facets. One is that the initial materials, i.e., cotton/polyester/cellulosic fiber blends of fabric, can be broke down into their more elementary compounds, which can be of interest as a product. The other facet is that the solvent itself is recovered in the end of the process to be reused as solvent during the next cycle of the process. Thus, the disclosed recycling process by means of a solvent is inherently different form elsewhere disclosed methods, e.g., patent application U.S. Pat. No. 5,601,767 A or U.S. Pat. No. 5,189,152 A, where the focus lies on shaping/molding the initial materials, even if a similar solvent is used.

The method also comprises filtering the mixture and determining a concentration of NMMO in the mixture. The method further comprises drying of the mixture, at e.g., 50° C., for 24 hours. The filtering is done, e.g., using a 1 mm metal sieve. In the method the determining of the concentration of NMMO is done using a homogenizer.

The system for regenerating cellulose from waste textile comprises a container, a heater, and a stirring unit. The container is used for holding at least one of a sample and an aqueous solution of high concentration, i.e., at least 85% (w/w), NMMO creating a mixture. The heater is thermically connected to the container for heating the container comprising mixture. The stirring unit is used for stirring of the heated mixture in the container.

The system further comprises a fluid ingress for inputting the at least one of the sample and the aqueous solution of high concentration NMMO into the container. A fluid outlet for removing of the heated mixture from the container is also provided. The system optionally also comprises a filtration device for filtration of the heated mixture.

The method and system enable the regeneration of the cellulose from cotton/polyester/cellulosic fiber blends of fabrics and provide a cyclical process that can reuse the solvent N-methylmorpholine N-oxide (NMMO). The NMMO solvent is collected liquid, i.e., as aqueous solution of NMMO, to be filtered and refined back into high concentration NMMO to be used again.

### DESCRIPTION OF THE FIGURES

FIG. 1 shows an overview of a method for regenerating cellulose from waste textiles.

FIG. 2 shows the method for regenerating the cellulose from the waste textiles.

FIG. 3 shows an XRD graph for samples produced using the method.

FIG. 4a shows samples comprising cellulosic materials before a washing process.

FIG. 4b show samples comprising cellulosic materials after the washing process.

### DETAILED DESCRIPTION OF THE INVENTION

The invention will now be described on the basis of the figures. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

### Materials—Reagents

Waste textiles 15 were used in a method 100 from a blue and green striped 40/60 polyester/viscose blend. At least 50% (w/w in H₂O) concentration of N-methylmorpholine N-oxide (NMMO) from Sigma Aldrich was used initially. Said concentration, referred as initial or low NMMO concentration in the following, can be increased up to, but not reaching, 85%. At least a concentration of 85% NMMO (w/w in H₂O) was used to dissolve the waste textiles. Said concentration, referred as elevated or high NMMO concentration in the following, can be increased up to 97%. The given concentrations values refer to the mass ratios of NMMO in aqueous solution (i.e., mass of NMMO/mass of H₂O). Additionally, 1 M cupriethylenediamine was used as solvent in a viscosity test. The ratio of grams of waste textiles, i.e., fabric, to milliliters of NMMO can range from 1:10 to 1:20.

The pH value is likely to be a variable during the process. Thus, materials to alter the pH value or pH buffer substances will also be required. Examples of such materials, include but are not limited to, carbonic acid (H2CO3), sodium acetate (CH3COONa), and/or acetic acid (CH3COOH).

### Materials—Samples

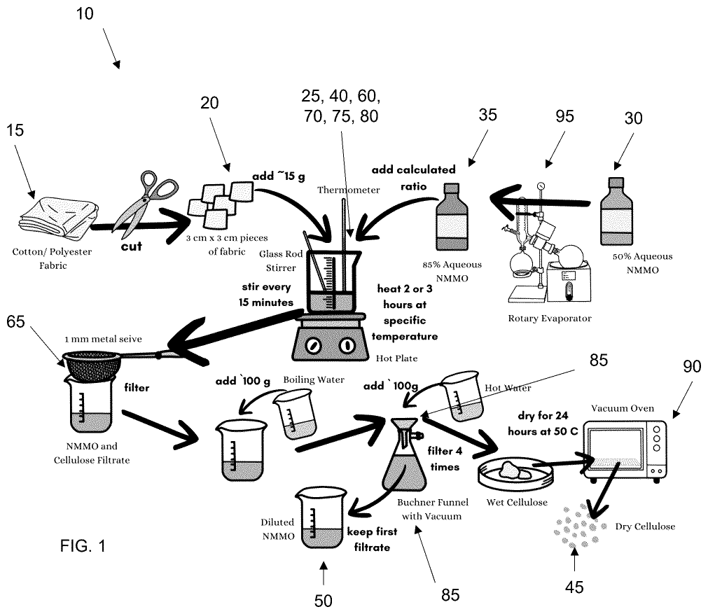

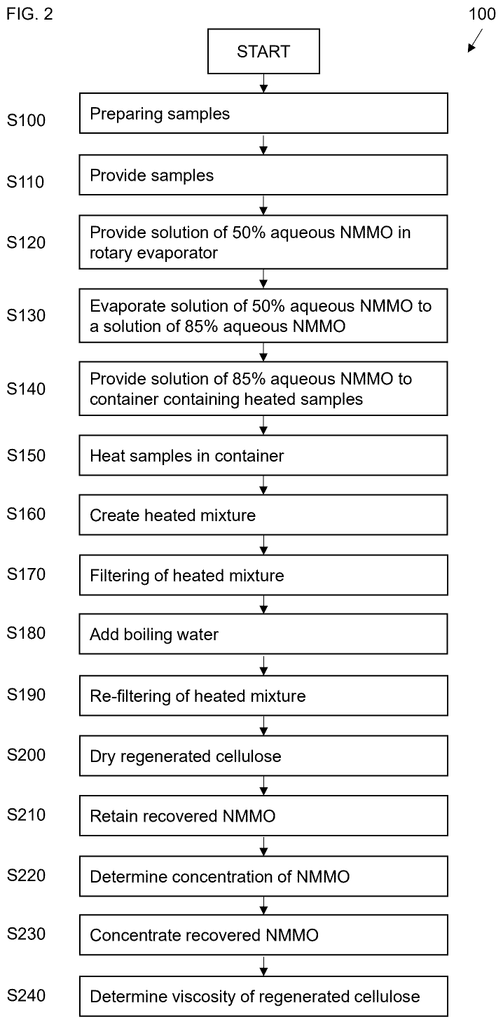

FIG. 1 shows an overview of a method 100 for regenerating cellulose 45 from waste textiles 15 according to one aspect of this document. FIG. 2 illustrate steps of the method 100. The waste textiles 15 are cut in samples 20 of approximately 3 cm×3 cm in size in step S100 of the method 100. In one aspect, the waste textiles 15 were from a blue and green striped 40/60 polyester/viscose blend. It will be appreciated that other types of waste textiles can be used. Non-limiting examples include, but are not limited to, polyester, cotton, or cellulosic fibers and any blend comprising varying amounts of the named three initial materials.

The sample 20 contains approximately 2.5 g of fabric, but this is not limiting of the invention. The samples 20 of fabric are mixed with a 1:15 or 1:20 (v/w) ratio of high NMMO concentration, e.g., 85% (w/w), in one non-limiting aspect. Concentrations up to 97% NMMO are also possible. The NMMO is used as a solvent for the separation process of cellulose from cotton/polyester/cellulosic fiber blends of fabrics. The samples 20 are provided through an opening 80 in a container 25 in step S110. The samples 20 are provided, for example, through an opening 80 of the container 25.

An aqueous solution of low NMMO concentration 30, e.g., 50% (w/w in H2O), is provided in a rotary evaporator 95 (from Heidolph) in step S120. In other examples, it would be possible to use a solution of up to, but not reaching, 85% NMMO concentration 30. The aqueous solution of low NMMO concentration 30 is evaporated to an aqueous solution of high NMMO concentration 35, e.g., 85% (w/w in H₂O), in step S130. The aqueous solution of high NMMO concentration 35 is provided to the container 25 containing the samples 20 in step S140 immediately followed by the next two steps S150 and S160. The aqueous solution of high NMMO concentration 35 is provided via a fluid ingress 70 fluidly connected to the container 25. The container 25 comprising the samples 20 is heated to a temperature in the range between 100° C. and 120° C. for, in one aspect, 2 to 3 hours in step S150. The heating is done using a heater 55. The container 25 containing the heated samples (20) and the aqueous solution of high NMMO concentration 35 is stirred every 15 minutes for 2 to 3 hours in step S160 thereby mixing the heated samples 20 and the aqueous solution of high NMMO concentration 35 to a heated mixture 40. The stirring is done using a stirring unit 60 disposed in the container 25. The heated mixture 40 is filtered using a filtration device 65, such as a 1 mm metal sieve, in step S170.

A total of 100 g of boiling DI water is added to the filtered heated mixture 40 in step S180. The filtered heated mixture 40 is re-filtered in step S190 using a vacuum filtration device 85. During the re-filtering in step S190 additional hot water may be added. The re-filtering in step S190 is continued until the heated mixture 40 is separated into polyester 46, regenerated cellulose 45, and recoverable NMMO 50. Usually, it takes only one re-filtering step S190 leading to a liquid phase of recovered/reusable NMMO 50 as filtrate. The gained cellulose 45 is removed from the container 25 via a fluid outlet 75. The fluid outlet 75 is fluidly connected to the container 25. The regenerated cellulose 45 is dried for, e.g., 15 min, using a vacuum oven 90 in step S200. The recovered NMMO 50 is retained for reuse in a beaker in step S210. In other aspects of the method, the regenerated cellulose 45 is dried for up to 24 hours.

### Materials—Apparatuses and Tools

The rotary evaporator 95 was used to convert the aqueous solution of low NMMO concentration 30, e.g., 50% (w/w in H₂O), to the aqueous solution of high NMMO concentration 35, e.g., 85% (w/w in H₂O), in step S130. The containers 25 used to dissolve the textiles include beakers ranging in size from 50 mL to 500 mL, hot plates, mercury thermometers, aluminum foil, glass stirring rods, a metal spatula, a metal mesh sieve, and Pyrex dishes filled with paraffin oil. A Büchner funnel and flask was used for vacuum re-filtration along with P2 filter paper from Fisher in step S190. The regenerated cellulose 45 was dried in a vacuum oven 90. A glass capillary viscometer was used for viscosity testing in a large water bath, as well as a motorized pipette controller and plastic pipette tips.

### Methods—Preparation of Materials

The cotton/polyester/cellulosic fabric is cut into approximately 3 cm×3 cm pieces and measured out in ˜15 g sample sizes in step S100. The exact mass of the samples 20 is recorded. The aqueous solution of low NMMO concentration 30, e.g., 50% (w/w in H₂O), undergoes a rotary evaporation procedure to be concentrated into the aqueous solution of high NMMO concentration 35, e.g., 85% (w/w in H₂O), in step S130.

Methods—Dissolving of Cotton/Polyester fabric

Various ratios of fabric weight to milliliters of NMMO are calculated and measured for different sample 20 numbers. The fabric pieces and 85% NMMO for the samples 20 are combined in the labeled beakers and placed in hot oil baths at varying temperatures. The samples 20 were stirred with the stirring unit 60 (such as a glass rod) at 15-minute intervals, but some were heated for 2 hours and others at 3 hours to test the impact of temperature and duration. The following table 1 illustrates the results for different ones of the specifications of the samples 20. The values can range within the uncertainties of ±10% for the concentration, ±15 min for the treatment time, and ±10° C. for the temperature.

TABLE 1

| Sample # | Time | Ratio/Concentration | Temperature |
|---|---|---|---|
| (identical composition) | (hours) | (g fabric:mL NMMO) | (° C.) |
| 1 | 2 | 1:10 | 120 |
| 2 | 2 | 1:20 | 120 |
| 3 | 2 | 1:15 | 100 |
| 4 | 2 | 1:20 | 100 |
| 5 | 3 | 1:15 | 120 |
| 6 | 3 | 1:20 | 120 |
| 7 | 3 | 1:15 | 100 |
| 8 | 3 | 1:20 | 100 |

### Methods—Filtration of Dissolved Cellulose

The heated solution is pressed (either by the said solution's own weight or with additional pressure imposed by hand) through a metal, 1 mm, sieve and washed with approx. 100 g of aqueous solution of low NMMO concentration, e.g., 50% (w/w in H₂O), and heated water to aid in releasing the cellulose from the leftover polyester fibers, i.e., the polyester is recovered from the blended fabrics after dissolving the cellulosic parts, in step S170. The resulting solution is collected in one of the beakers and labeled with the sample number. Then, 350 mL of boiling water is added to the solution while the solution is continuously mixed with a glass stir rod in step S180. The solution is then left overnight before further filtration.

The following day, the solution is re-filtered through a Buchner funnel with P2 filter paper with approx. 100 g of warm water for washing in step S190. The recovered NMMO 50 is collected in step S210 and set to the side to be regenerated into the concentrated, i.e., the aqueous solution of high NMMO concentration. This process is repeated 3 more times without further filtrate being collected, and then the cellulose is allowed to dry by the suction filtration, e.g., using a Cole-Parmer vacuum pump.

### Methods—Drying of the Cellulose

The cellulose was collected and placed in a petri dish, then covered with aluminum foil and labeled with its sample number. The cellulose was then placed in a vacuum oven 90 at 50° C. for, e.g., 24 hours, in step S200. Usually more than 90% of the re-gained fibers met the purity and/or quality criteria as specified in table 2. In other aspects, the cellulose can be placed for only 20 minutes in the vacuum oven 90 without violating the purity and/or quality specifications of table 2, which were obtained during subsequent purity and/or quality tests.

### Methods—Regenerating NMMO

The recovered NMMO 50 is collected in step S210. The recovered NMMO 50 is placed in a homogenizer step S220 to determine a concentration of the recovered NMMO 50. The recovered NMMO 50 was then placed in the rotatory evaporator 95 to be concentrated to ≥85% NMMO (w/w in H₂O) in step S230.

### Methods—Testing Viscosity

Viscosity of the regenerated cellulose 35 is determined in step S240. Determining the viscosity comprises collecting a small portion of the dried cellulose and recording a weight of the small portion. The small portion is then dissolved in a solution of 25 mL of the recovered NMMO 50 and 25 mL of deionized (DI) water. This solution was shaken vigorously to enable dissolution and left for at least an hour and up to overnight (8-10 hours).

Determining the viscosity of the regenerated cellulose 35 further comprises running a control test run on a 1:1 water:recovered NMMO 50 solution. 7 mL of this water/NMMO solution is placed into the viscometer and put into a water bath, e.g., at 25° C. A power-pipette is used to pull the solution above the top bulb of the viscometer. Then, the time taken for the solution to fall from the line above the bulb to the line below is measured and recorded. The viscometer is emptied, and the process is repeated for at least two trials or until there is a <5% difference in the times recorded. This process is repeated the samples, and the times are averaged.

### Methods—XRD Test

Half of the dried cellulose was put through an X-Ray Diffraction (XRD) test to determine its crystallinity. The XRD test is a non-destructive test method used for analyzing a structure of crystalline materials and is used to identify the crystalline phases present in a material to thereby reveal chemical composition information. Identification of the crystalline phases is achieved by comparison of the acquired data to that in reference databases. X-ray diffraction is useful for evaluating minerals, polymers, corrosion products, and unknown materials. In most cases, the samples are analyzed by powder diffraction using samples prepared as finely ground powders.

### Methods—Purity/Quality Test Specifications

Table 2 shows the specifications for some of the tests done in order to evaluate the purity and/or quality of, e.g., the dried cellulose.

TABLE 2

| | | |
|---|---|---|
| Particulars | Specification | Test method |

Critical Characteristics

| | | |
|---|---|---|
| Alpha cellulose | >96 | TAPPI T 203 test method |
| Hemicellulose | <4 | Van Soest method 6 |

Solubility Characteristics

| | | |
|---|---|---|
| S10 | <5 | solubility in a 10% |
| | | concentration of NaOH |
| S18 | <2.5 | solubility in a 18% |
| | | concentration of NaOH |

Impurity Profile

| | | |
|---|---|---|
| Ash % | <0.1 | ASTM D 3516 - 89 |
| Acid Insolubles ppm | <20 | ASTM E1721-01 (2015) |

Others

| | | |
|---|---|---|
| Intrinsic viscosity | Treatment and | Dilute Solution |
| (CED, ml/g) | feedstock specific | Viscometry (DSV) |
| for DGP, may be | (480-530 for | ASTM D1795Th |
| different for cotton | DGP) | |
| recycle | | |
| Whiteness (Berger) | >80 | ASTM E313 and |
| | | ASTM D9125 |
| Brightness (ISO) | >90 | ISO 2470 |

The values on purity and/or quality of, e.g., dried cellulose, were double-checked through several independent runs of method 100 with subsequent testing of the purity and/or quality according to table 2.

### Data Calculations—Percentage Yield

A percent yield of regenerated cellulose 45 from each sample is found by dividing a mass of the vacuum-dried cellulose by the starting mass of the cellulose.

$$PercentYield = \frac{massofdriedcellulose}{massofstartingcellulose} \times 100 \%$$

### Data Calculations—Viscosity

The viscosity was found by first comparing the time recorded by a viscometer of type Cannon™ Ubbelohoe (Calibrated, Size 100) for the recovered NMMO 50 to the time recorded for the sample with the following equation. μᵣₑₗ is a relative viscosity, tₛ is the time for the sample, and to is the time for the recovered NMMO 50.

$${μ}_{rel} = \frac{ts}{{t}_{0}} \frac{t}{{t}_{0}}$$

Next, a concentration for the sample is found by dividing the weight (in grams) of the added sample 20 by the volume (in milliliters) of the recovered NMMO 50 in which the sample 20 was dissolved.

To find the specific viscosity, the following equations were used, where μₛₒₗᵤₜᵢₒₙ is the viscosity of the heated mixture 40 and where μₛₒₗᵥₑₙₜ is the viscosity of the recovered NMMO 50.

$${μ}_{spec .} = \frac{( {μ}_{solvent} - {μ}_{solution} )}{{μ}_{solution}}$$

$$or {μ}_{spec .} = μ - rel - 1$$

An intrinsic viscosity describing a measure of a solute's contribution to the viscosity n of a solution is calculated using the following equation where η_{specific} is the specific viscosity of the solvent and c is a concentration of the solvent in g/ml.

$$Intrinsicviscosity [ η ] = \frac{{η}_{specific}}{c}$$

### Results

Table 3 shows results for use of the method 100 for regenerating the cellulose from the cotton/polyester/cellulosic fiber blends of fabrics. As can be seen from the table (table 3), the method yielding the highest percentage yield can be achieved when using longer process times, i.e., 3 hours, and using a temperature of 120° C.

TABLE 3

| | | | | Intrinsic | | |
|---|---|---|---|---|---|---|
| Sample | Time | | Temperature | viscosity | Percent | |
| # | (hours) | Ratio | ° C. | (ml/g) | yield | XRD |
| 1 | 2 | 1:10 | 120 | 259.93 | 11.33 | 5 |
| 2 | 2 | 1:20 | 120 | 240.61 | 62.42 | 4 |
| 3 | 2 | 1:15 | 100 | 292.41 | 41.98 | 1 |
| 4 | 2 | 1:20 | 100 | 281.77 | 24.90 | 3 |
| 5 | 3 | 1:15 | 120 | 180.21 | 70.72 | 1 |
| 6 | 3 | 1:20 | 120 | 170.05 | 95.64 | 3 |
| 7 | 3 | 1:15 | 100 | 217.09 | 56.05 | 2 |
| 8 | 3 | 1:20 | 100 | 237.83 | 56.88 | 6 |

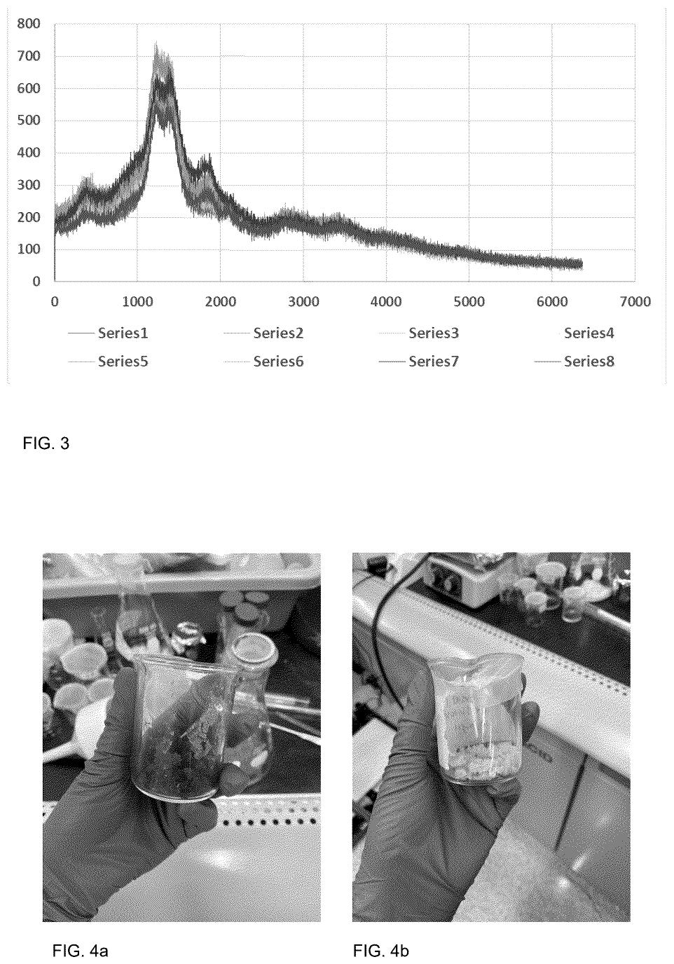

FIG. 3 shows an XRD graph, where the intensity is plotted over the angle 20, for samples produced using the method 100 described in above table (table 3). Furthermore, the figure (FIG. 3) illustrates the crystallinity of the samples and how the samples changed from the pure cellulose fibers and that, after the treatment by means of the method 100, the recovered cellulose has the properties and integrity suitable for fiber spinning, i.e., viscosity needs to be between 200 and 400 ml/g and crystallinity similar to the crystallinity of cellulosic fibers. The similarity in terms of crystallinity is evaluated by comparing the areas underneath the respective XRD peaks of recovered cellulose fibers and pure cellulose fibers.

FIG. 4a shows samples comprising cellulosic materials after the separation treatment, but before rinsing with water. Cellulosic pulps before rinsing are presented inside a transparent jar.

FIG. 4b show samples comprising cellulosic materials after the separation treatment and after rinsing with water. Cellulosic pulps after rinsing are presented inside a transparent jar.

### REFERENCE SIGNS

10 system
15 waste textile
20 sample
25 container
30 aqueous solution of low NMMO concentration, e.g., 50% (w/w in H₂O)
35 aqueous solution of high NMMO concentration, e.g., 85% (w/w in H₂O)
40 heated mixture
45 regenerated cellulose
46 polyester
50 recovered/reusable NMMO
55 heater
60 stirring unit
65 filtration device
70 fluid ingress
75 fluid outlet
80 opening
85 vacuum filtration device
90 vacuum oven
95 rotary evaporator
100 method

1. A method for regenerating materials from textiles, the method comprising:
providing samples of the textile to a container;
adding an aqueous solution of NMMO to the container;
heating the container thereby creating a mixture;
filtering the mixture using a vacuum filtration device; and
drying the filtered mixture using a vacuum oven to recover the materials.

2. The method according to claim 1, further comprising:
filtering of the mixture.

3. The method according to claim 1, further comprising:
determining a concentration of the NMMO in the mixture.

4. The method according to claim 1, wherein
the drying is done at around 50° C. for at least 15 minutes and at most 24 hours.

5. The method according to claim 2, wherein
the filtering is carried out using a 1 mm metal sieve.

6. The method according to claim 3, wherein
the determining is done using a homogenizer.

7. The method according to claim 1, wherein the aqueous solution of NMMO has a concentration between 50% and 97%.

8. The method according to claim 1, wherein the ratio of the textile to the aqueous solution of NMMO is between 1:15 and 1:20.

9. The method according to claim 1, wherein the container is heated to a temperature in the range between 100° C. and 120° C.

10. The method according to claim 1, wherein the container is heated for a heating time of 2 to 3 hours.

11. A system for regenerating cellulose from textile, the system comprising:
a container for holding at least one of a sample of the textile and an aqueous solution of NMMO creating a mixture;
a heater for heating of the container comprising the mixture; and
a stirring unit for stirring of the heated mixture in the container.

12. The system according to claim 11, further comprising
a fluid ingress for inputting the at least one of the sample and the aqueous solution of NMMO in the container.

13. The system according to claim 11, further comprising
a fluid outlet for removing the heated mixture from the container.

14. The system according to claim 11, further comprising
a filtration device for filtration of the heated mixture.

15. The system according to claim 11, wherein the concentration of the aqueous solution of NMMO is in the range of 50-97% w/w.

16. The system according to claim 11, wherein the concentration of the aqueous solution of NMMO is at least 85% w/w.
